(19) United States
(12) Patent Application Publication
(10) Pub. No.: US 2010/0293453 A1
(43) Pub. Date: Nov. 18, 2010

(54) SYSTEM AND METHOD FOR PRODUCING AND USING ELECTRONIC MEDIA SCHEDULES

(76) Inventor: Eitan D. Schwarz, Wilmette, IL (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/771,442

(22) Filed: Apr. 30, 2010

Related U.S. Application Data
(60) Provisional application No. 61/179,355, filed on May 18, 2009.

(51) Int. Cl. G06F 3/14

(52) U.S. Cl. 715/234

(57) ABSTRACT

An electronic media organizer is provided to aid administrators to produce, for a user, a weekly electronic media schedule that prescribes a balance of electronic media from various categories of electronic media for an appropriate amount of time per week, based on the user's age and developmental needs. The electronic media organizer automatically creates a daily media schedule based on the weekly media schedule. The electronic media organizer may also automatically schedule daily supervised time for a user based, at least in part, on schedule information provided by an administrator associated with the user. Information about the user's electronic media consumption, and behavior in conjunction with such consumption, may be recorded and provided as feedback to an administrator. A video game is also described, which utilizes information in a user's weekly media schedule to present a game to the user that is informed by the media schedule.

### BENEFIT CLAIM

This application claims benefit of Provisional Appln. 61/179,355, titled “SYSTEM AND METHOD FOR DELIVERING MEDIA”, filed May 18, 2009, the entire contents of which is hereby incorporated by reference as if fully set forth herein, under 35 U.S.C. §119(e).

### FIELD OF THE INVENTION

The present invention relates to an electronic media organizer configured to aid an administrator, such as a parent, to produce for a user, such as a child, an electronic media schedule that prescribes a balance of electronic media from various categories of electronic media for an appropriate amount of time per week, based on the user's age and psychological needs.

### BACKGROUND

The accessibility of electronic media increases over time as technology becomes more affordable. Children today have unprecedented access to electronic media of all kinds, including web pages, video games, television programs, movies, applications run on various kinds of stationary and mobile computing devices, telephone calls, and other electronic entertainment.

Electronic media is very attractive to the juvenile mind, and many times such media is specifically marketed toward children. As children spend a greater percentage of their time consuming electronic media content, the influence of themes in the electronic media increases in the children's lives. Consuming electronic media may involve participating in a video game, browsing documents on the Internet, interacting with computer games, talking or texting on the telephone, watching a video, making purchases with a credit card, etc.

Unhealthy levels of unsupervised and unrestrained consumption of electronic media content use may cause children to interact less with their family, to engage in less imaginative play, and to allow their grades to drop, among other harmful things. These negative trends are caused, in part, by themes in the children's choice of electronic media content. Specifically, children gravitate toward so-called junk media, which is designed for pure entertainment purposes, and can include themes that are not healthy for children.

Mechanisms exist to restrict a person's access to electronic media. For example, parents can implement browser filters that eliminate access to documents on the Internet that include designated keywords or that are in certain domains of the Internet. However, it is difficult to make Internet filters that restrict all unwanted Internet documents. Furthermore, filters do not allow for actively prescribing, for a person, electronic media containing desirable themes. Furthermore, filters do not allow parents to implement any kind of long-term plan for the role of electronic media in the progression of a child, or to provide a way to enhance the quality of family life.

Studies have shown that mere restricting and filtering electronic media have little influence on children's harmful usage of media. After a decade of intense and increasing electronic media content consumption by children, there still is no systematic, practical, and comprehensive family resource to help parents provide healthy electronic media consumption for their children. No method has been described that prescribes an amount and quality of supervision for a child.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that depicts an example network arrangement for generating a media schedule for a user, based on the user's age, and monitoring the user's electronic media content consumption based on the generated media schedule.

FIG. 2 is a flowchart illustrating example interactions between administrators/users and an electronic media organizer.

FIG. 3 illustrates example electronic media organizer rules for users ages two, five, eight, twelve, and seventeen.

FIG. 4 illustrates an example graphical user interface displaying a recommended weekly media schedule and containing fields for receiving adjustments to the recommended weekly media schedule.

FIG. 5 illustrates an example method of generating a daily media schedule for a user based on an adjusted weekly media schedule and automatically updating the daily media schedule based on user behavior.

FIG. 6 illustrates an example method of generating a daily schedule of supervision for a user, monitoring the actual supervised electronic media content consumption time, and adjusting the daily schedule of supervision based on the actual supervised time.

FIG. 7 illustrates an example method of basing the presentation of video game modules to a user on a weekly media schedule for the user.

FIG. 8 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

An electronic media organizer is described herein to aid administrators, such as parents, to produce for a user, such as a child, an electronic media schedule that prescribes electronic media from various categories of electronic media for an appropriate amount of time per week, based on the user's age and developmental needs. The electronic media organizer presents a proposed weekly media schedule to the administrator, who may adjust the weekly media schedule, if desired. The electronic media organizer then automatically creates a daily media schedule based on the adjusted weekly media schedule.

A media schedule for a user includes amounts of time, per day or week, that the user should spend on electronic media categorized under various Growth Opportunity media categories. Each Growth Opportunity represents a theme of the electronic media categorized thereunder, e.g., Values Education, Socialization, etc. A weekly media schedule may also indicate an amount of electronic media consumption time that is to be supervised. The electronic media organizer may automatically schedule daily supervised time for a user based, at least in part, on schedule information provided by an administrator associated with the user.

The electronic media organizer identifies a user, e.g., by presenting to a user a log in web page and authenticating the user's log in information, and guides the user through the user's daily or weekly media schedule. Information about the user's electronic media content consumption, and behavior in conjunction with such consumption, may be recorded and provided as feedback to an administrator for the user.

A video game is also described, which utilizes information in a user's media schedule to present a game to the user that is informed by the media schedule. Such a video game contains the same balance of Growth Opportunities as that set out by the media schedule. The video game may also monitor a user's reactions to the game and provide feedback on the user's reactions to an associated administrator. Also, the video game may reward points in a randomized fashion, such that the user does not know, based on past play, an amount of points that will be received for any given choice in the video game.

### Electronic Media Organizer Architecture

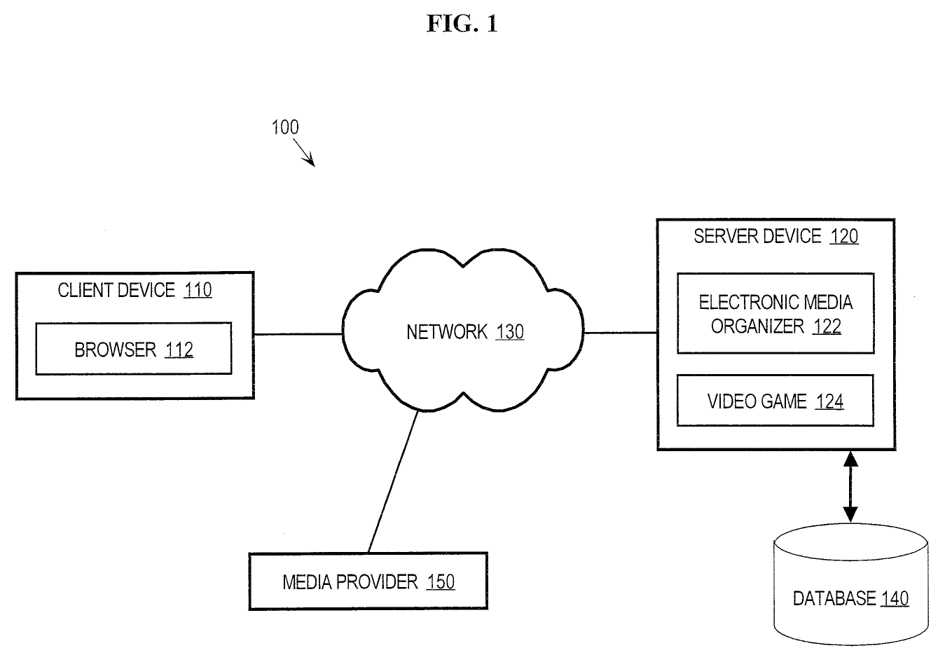

In one embodiment of the invention, the electronic media organizer resides on a server and communicates with users and administrators over a network. FIG. 1 is a block diagram that depicts an example network arrangement 100 for generating a media schedule for a user, based on the user's age and developmental or psychological needs, and for monitoring the user's electronic media content consumption, according to embodiments of the invention. Example network arrangement 100 includes a client device 110, and a server device 120, communicatively coupled via network 130. Server device 120 is also communicatively coupled to database 140. Example network arrangement 100 also includes media provider 150, which is communicatively coupled to server device 120 and to client device 110 via network 130.

Client device 110 may be implemented by any type of client device. Example implementations of client device 110 include, without limitation, workstations, personal computers, laptop computers, personal electronic assistants (PDAs), telephony devices, televisions, personal media players, devices that facilitate using a credit card to make purchases, other computing devices, and any other type of device capable of presenting electronic media content for consumption. In example network arrangement 100, client device 110 is configured with a browser 112. Browser 112 is configured to interpret and graphically display web pages received over network 130, such as Hyper Text Markup Language (HTML) pages, and Extensible Markup Language (XML) pages, etc. In one embodiment of the invention, client device 110 is configured without browser 112. Client device 110 may also be configured with other mechanisms, processes, and functionality, depending upon a particular implementation.

Client device 110 is configured to communicate with other devices, such as server device 120 and media provider 150, over network 130. Network 130 may be implemented with any type of medium and/or mechanism that facilitates the exchange of information between client device 110 and server device 120. Furthermore, network 130 may use any type of communications protocol, and may be secured or unsecured, depending upon the requirements of a particular application.

Server device 120 may be implemented by any type of device that is capable of communicating with client device 110 over network 130. In example network arrangement 100, server device 120 is configured with electronic media organizer 122. Electronic media organizer 122, as explained in more detail below, is capable of generating web pages to be sent over network 130 to client device 110 to facilitate communication between electronic media organizer 122 and a user of client device 110. Electronic media organizer 122 is further configured to receive information over network 130, e.g., through File Transfer Protocol (FTP), SSH File Transfer Protocol (SFTP), HyperText Transfer Protocol (HTTP), etc.

Electronic media organizer 122 may be implemented in computer hardware, computer software, or any combination of computer hardware and software. As one nonlimiting example, electronic media organizer 122 may be implemented as one or more software processes. For purposes of explanation, embodiments of the invention are described herein primarily in the context of electronic media organizer 122 providing information to client device 110 in the form of web pages to be processed by browser 112. The invention is not limited to this context however, and electronic media organizer 122 may provide information to client device 110 in other forms. As one example, electronic media organizer 122 may provide data to client device 110 in the form of messages or other data forms that are processed by a software process other than browser 112 executing on client device 110.

In another embodiment of the invention, client device 110 is configured with an electronic media organizer client. For example, one or more modules of an electronic media organizer client may be implemented as a part of browser 112, e.g., as a plug-in. As another example, an electronic media organizer client may be implemented as a stand-alone application on client device 110. In yet another embodiment of the invention, hardware that implements electronic media organizer 122 or an electronic media organizer client is included on client device 110. An electronic media organizer client may communicate with server device 120 via network 130, for example, to receive updated media schedules for a user that logs onto electronic media organizer 122 from client device 110. The electronic media organizer client may perform one or more of the functions described herein for electronic media organizer 122.

In yet another embodiment of the invention, electronic media organizer 122 is implemented in whole, or in part, by one or more electronic media content providers, represented by media provider 150, as described in further detail below. Media provider 150 may be implemented by any type of device or entity that is capable of communicating, via network 130, with client device 110 and server device 120, and capable of providing electronic media or content to client device 110. Media provider 150 may be the sole provider of electronic media content to a user of client device 110, multiple media providers may provide content to a user of client device 110, or electronic media content may be delivered to client 110 from another source.

Server device 120 is also configured with video game 124. Video game 124, residing on server device 120, is configured to be accessed and played via network 130. Video game 124 may be implemented as part of electronic media organizer 122, may be implemented as a separate entity on server device 120, or may reside on a device other than server device 120. For example, as described in further detail below, video game 124 may reside on client device 110. Server device 120 may be configured with other mechanisms, processes and functionalities, depending upon a particular implementation.

Server device 120 is communicatively coupled to database 140. Database 140 may be implemented by any type of storage, including volatile and non-volatile storage. Examples of database 140 include, without limitation, random access memory (RAM), read-only memory (ROM), and one or more disks. Database 140 may be external to server device 120, as shown in example network arrangement 100, or may be implemented as an internal component of server device 120.

### Electronic Media Organizer

In one embodiment of the invention, electronic media organizer 122 is configured to aid administrators in creating an electronic media schedule for one or more users. In one embodiment of the invention, a user accesses any and all digital media solely through electronic media organizer 122. For ease of illustration, electronic media organizer 122 is occasionally described in the context of a parent/child relationship, but is not limited to such use. For example, electronic media organizer 122 may be used by school officials and students, or by government officials and children in foster care, or by medical personnel and adult or juvenile patients, etc. As the term is used herein, an administrator may only configure the settings and receive feedback for users that are associated with the administrator.

Electronic media organizer 122 may include groups of administrators and users. An administrator may join a particular group by identifying the group to electronic media organizer 122. Electronic media organizer 122 may associate the administrator and the users associated with the administrator with a group identifier for the group. Electronic media organizer 122 may allow an administrator associated with a group to view and/or access the media schedules for users in the group, categorization of electronic media performed by administrators in the group and feedback compiled for the users in the group, as described in further detail below.

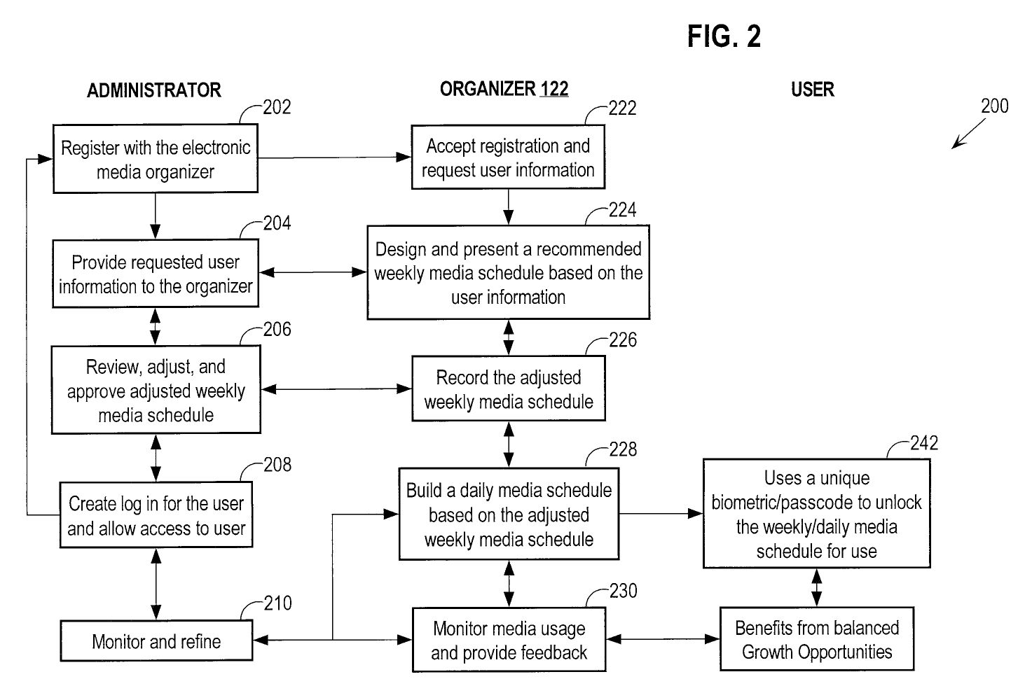

FIG. 2 is a flowchart 200 illustrating example interactions between administrators/users and electronic media organizer 122 (“organizer 122”). The steps of flowchart 200 may be performed in any order, and are not limited to the order in which they are described herein. At step 202, an administrator registers with organizer 122. For example, an administrator on client device 110 (FIG. 1) may request that organizer 122 generate and send a registration web page to client device 110. The administrator may use browser 112 to access the generated registration web page to register for services provided by organizer 122.

At step 222, organizer 122 accepts the administrator's registration and requests user information from the administrator. For example, organizer 122 may include registration information for the administrator in a database of subscribers, e.g., at database 140, and then may request information about a user for whom a media schedule is to be developed. User information that organizer 122 may request from an administrator includes one or more of age, gender, user health factors, language, interests, demographic, level of autonomy, pairing links to other users, and information about specific health, developmental, and psychological needs such as learning disabilities and cognitive disorders. Organizer 122 may also request information about the schedules of people who may supervise electronic media content consumption of the users (“supervisors”), including specific weekly times when the supervisors would be available to participate in electronic media with the user.

At step 204, the administrator provides the requested user information to organizer 122. For example, the administrator may fill out a form on a web page provided by organizer 122, via network 130, that includes fields for each item of requested information. The administrator may then submit the form via network 130 to electronic media organizer 122. As another example, the administrator may input information for a user through other means, such as voice recognition, reference to a database containing the user information such as databases of school records, medical reports, etc. Organizer 122 may request information verifying that the administrator has a relationship to the user, e.g., proof of being a parent of the user. Organizer 122 may store the user information in conjunction with the administrator's registration information in database 140.

At step 224, organizer 122 designs and presents a recommended weekly media schedule for the user based on the received user information. Weekly media schedules refer to categories of media. Specifically, electronic media may be categorized based on themes included in the electronic media. Such categories of electronic media are referred to herein as Growth Opportunities. Example Growth Opportunities include, without limitation, Family Relationships, Values Education, Socialization, Education Enrichment, and Entertainment. Growth Opportunities may be organized into a hierarchy, wherein media from one or more Growth Opportunities is considered preferable to media from other Growth Opportunities. For example, media categorized under Family Relationships and Values Education may be considered preferable to media categorized under Entertainment. Organizer 122 may base daily schedules and/or daily media suggestions, etc., on such a hierarchy.

Electronic media organizer 122 may access a database of rules, e.g., at database 140, that prescribe amounts of time that users of various ages should consume electronic media categorized under the Growth Opportunities. Such rules may be based on medically-credible principles for promoting the psychological health and healthy family life of a user. The rules may indicate a quantity of time each week that a user of a particular age with particular psychological and developmental needs should spend with electronic media from each Growth Opportunity. The weekly media schedule recommended by organizer 122 for a user is based on these rules. Thus, according to one embodiment of the invention, the mixture of electronic media content in the recommended media schedule for a user varies based on the age, psychological needs, and developmental needs of the user.

The electronic media categorized under a particular Growth Opportunity have a theme associated with the Growth Opportunity. Specifically, electronic media that is categorized under Family Relationships help support and develop a person's family relationships. For example, a website that promotes family relationships through genealogy or family history may be considered a Family Relationships website. Also, electronic media that promotes interaction among family members, such as a video game or computer game played by multiple family members, may also be categorized under Family Relationships.

Electronic media included in the Values Education Growth Opportunity provide moral and ethical guidelines for the person consuming the electronic media. For example, electronic media that promote the development of morals, or the Golden Rule, or that help a person give aid to other people through volunteer work may be categorized as Values Education.

The Socialization Growth Opportunity category includes electronic media that aids in a person's development of social skills. For example, media that teaches a person skills such as patience, kindness, peaceful conflict resolution, making friends, and keeping friends may be categorized under Socialization. Social networking websites may also be categorized under Socialization. The Socialization Growth Opportunity may also include electronic media that teaches a person how to be a good citizen or a good consumer, including teaching a person how to evaluate claims made about various products.

Electronic media included in the Education Enrichment category contribute to the intellectual, physical, and aesthetic development of a person. Such electronic media may help teach a particular skill, or may foster interest in particular subjects such as music, sports, government, citizenship, and science.

The Entertainment Growth Opportunity includes electronic media that entertains the user. Such electronic media may also be categorized under one of the other Growth Opportunities. As discussed in further detail below, time allocated for Entertainment electronic media is generally limited. Therefore, if electronic media may be categorized under a Growth Opportunity other than Entertainment, it is generally most beneficial to the user to do so.

### Categorizing Media

Electronic media may be categorized under one or more of the Growth Opportunities in any number of ways. For example, electronic media organizer 122 may include, e.g., in database 140, a library of electronic media that is categorized under suggested Growth Opportunities. Such suggested categorizations may be made available to administrators. Suggested categorizations for electronic media may be considered the default categorizations for the media for a particular user, which are adjustable by an administrator associated with the user. Alternatively, electronic media may be automatically categorized under a Growth Opportunity based on one or more attributes of the electronic media. For example, an uncategorized web page that includes the word “genealogy” may be automatically categorized, by organizer 122, under Family Relations based on the inclusion of the word.

An administrator may maintain a personal database of electronic media categorizations assigned by the administrator, which is stored at database 140 in conjunction with the administrator's information. As such, the administrator need not rely on the judgment of others in categorizing electronic media. An administrator may involve a user in the process of determining the categorization of electronic media. A user that takes ownership in the structure of the user's media schedule is more likely to support the schedule. For example, as any kind of electronic media may be categorized under Family Relations if multiple family members participate in the electronic media, a child may be more willing to follow the child's media schedule for Family Relations if the child is included in the decision as to what electronic media would be fun to participate in as a family.

Also, administrators may receive suggested categorizations of electronic media based on the categorizations assigned by other administrators associated with electronic media organizer 122. For example, an administrator may categorize a particular web site under Values Education and allow other administrators to see the categorization. In one instance, organizer 122 generates a web page that aggregates categorization information for the particular web site that has been submitted to the electronic media organizer 122 and displays the web page to those administrators that are interested in such information. In another instance, such aggregated categorization information is automatically included on a web page that an administrator uses to input personal categorization information into organizer 122.

In one embodiment of the invention, categorization of electronic media occurs prior to a user logging in to consume the electronic media. Such prior categorization may be used to restrict a user's access to only the electronic media categorized under the Growth Category scheduled for a particular day. In another embodiment of the invention, administrators categorize electronic media that has been previously consumed by the user. This embodiment may allow more flexibility in what the user may view on any given day.

In certain cases, electronic media includes themes from multiple Growth Opportunities. An administrator may choose to categorize such electronic media under a particular applicable Growth Opportunity. After a user has consumed electronic media content that includes themes from multiple Growth Opportunities during a particular week, an administrator may choose to change the categorization of the electronic media to better suit the needs of the user for the particular week.

Through organizer 122, an administrator may control any kind of electronic media available to a user. Such controls may be suggested by organizer 122. For example, organizer 122 may suggest that a child of a particular age should not have access to purchasing items using a credit card for any reason. As a further example, organizer 122 may suggest certain filters for Internet content that block specific documents, those documents that contain certain words or phrases, or documents that are sourced from a particular domain. An administrator may request that organizer 122 automatically implement all or a portion of the controls suggested by organizer 122. Organizer 122 restricts a user's access to electronic media based on the controls set by the associated administrator.

As a non-limiting example, through organizer 122, an administrator may control a user's telephone usage by restricting calls made to and/or received from a particular area code or phone number. Administrators may limit the duration of all telephone calls, or telephone calls from particular numbers. Controls may also be placed on the number of times a particular number is called from the user's device, or a number of times that a particular number may successfully place a call to the user's device in a given time period, e.g., day or week. Furthermore, an administrator may allow unlimited access to particular phone numbers, such as family phone numbers or school-related phone numbers. Also through organizer 122, an administrator may limit the transmission of images or text messages to other phones, or the receipt of images and text messages from other phones, based on a quantity of texts or images, the content of the texts or images, etc.

Organizer 122 may implement controls on Internet telephony devices and non-Internet based telephony devices. Controls on both Internet and non-Internet telephony devices may be implemented using software, hardware, telephony service providers, or any combination thereof.

As a further non-limiting example, an administrator may restrict a user's ability to purchase items using particular credit and debit card numbers. Restrictions may also be placed on the kinds of items that may be purchased, sources of purchases, and how much the user may spend on a given transaction or in a given time period.

### The Role of Providers

Controls and other functionality may be implemented by organizer 122 directly, or may be implemented, in whole or in part, by an electronic media provider, such as media provider 150 (FIG. 1). For example, media provider 150 may include information in electronic media provided to client device 110 that indicates one or more suggested Growth Opportunities in which to categorize the electronic media. Media provider 150 may also include information in the data for electronic media about suggested ages for consuming the electronic media content, in accordance with suggested standards associated with electronic media organizer 122. Organizer 122 may categorize and suggest particular items of electronic media for a particular user based on the information included in the data for electronic media by media provider 150. Such categorization may be reviewed and modified by an administrator.

Also, media provider 150 may configure the media provider's system to accept information about a user's media schedule and preferences set for a user on client device 110. Based on this user information, media provider 150 may provide to a user on client device 110 only electronic media that conforms with the media schedule and preferences set for the user. For example, media provider 150 may accept information identifying a particular user and a media preference for the particular user that the user may not view R-rated movies. Such a preference may be set by an administrator associated with the particular user. Based on the received preference, media provider 150 provides to the user only those movies that are not rated R. Media provider 150 may also provide content for only the amount of time indicated by the user's media schedule. Thus, providers may facilitate a user's conformance to the user's media schedule.

### Example Rules

As previously indicated, the recommended media schedule for a particular user is based on rules, at organizer 122, that indicate a quantity of time each week that a user of a particular age should spend with electronic media from each Growth Opportunity and the nature and amount of weekly supervision that should be provided for a user. In one embodiment, the rules included in the electronic media organizer 122 are based on the age of the user and one or more other factors, such as particular developmental needs, gender, demographic, user goals, administrator goals, past performance of the user, etc. The database of rules included in the electronic media organizer 122 may indicate a maximum and minimum amount of time for a user to consume electronic media each week, and/or a portion of weekly electronic media content consumption time that should be supervised. The rules database may be implemented using a relational database, or may be represented in a computer-readable flat file.

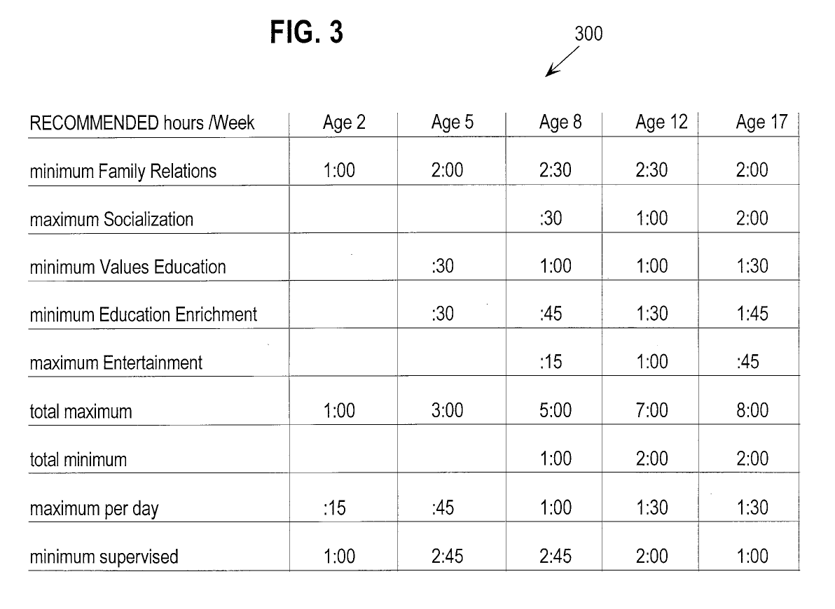

FIG. 3 illustrates example rules 300 for users ages two, five, eight, twelve, and seventeen. Example rules 300 are non-limiting in that the electronic media organizer rules may prescribe other time amounts for the depicted ages. Rules may include time amounts not included in example rules 300, such as minimum time with a supervisor nearby, maximum time working independently, hours/week with electronic media on particular devices, etc.

Rules 300 indicate that at age two, a child should be allowed one hour of Family Relations electronic media per week, should consume electronic media content for a maximum of one hour per week, at a maximum of 15 minutes per day. Rules 300 indicate that all of the time that a two-year-old spends consuming electronic media content should be supervised by an adult, such as a caretaker of the child.

Rules 300 indicate that, at age five, a child should be allowed a maximum of three hours per week to consume electronic media, with a maximum of 45 minutes per day. Two hours and 45 minutes of that time should be supervised. Two hours of the child's electronic media time should be devoted to Family Relations Growth Opportunities, 30 minutes to Values Education, and 30 minutes to Education Enrichment. At age eight, the child may consume electronic media from all of the Growth Opportunities. Such rules may include information for all possible age/developmental need combinations. Alternatively, organizer 122 may interpolate or extrapolate rules for a particular user based on the rules that are available to the organizer.

Example rules 300 indicate a minimum amount of time for Family Relations, Values Education, and Education Enrichment Growth Opportunities. Rules 300 indicate a maximum amount of time for Socialization and Entertainment Growth Opportunities. As such, example rules 300 make the time for Family Relations, Values Education, and Education Enrichment Growth Opportunities mandatory and the time for Socialization and Entertainment Growth Opportunities optional.

Returning to FIG. 2, at step 224, the electronic media organizer 122 may determine the rules that best apply to the user based on the information about the user provided to organizer 122. For example, the administrator indicates to organizer 122 that the user is an eight-year-old child with no special needs. Organizer 122 determines that the rules in example rules 300 that pertain to age eight best apply to the user. Organizer 122 then presents to the administrator a weekly media schedule based on the rules that pertain to age eight in rules 300.

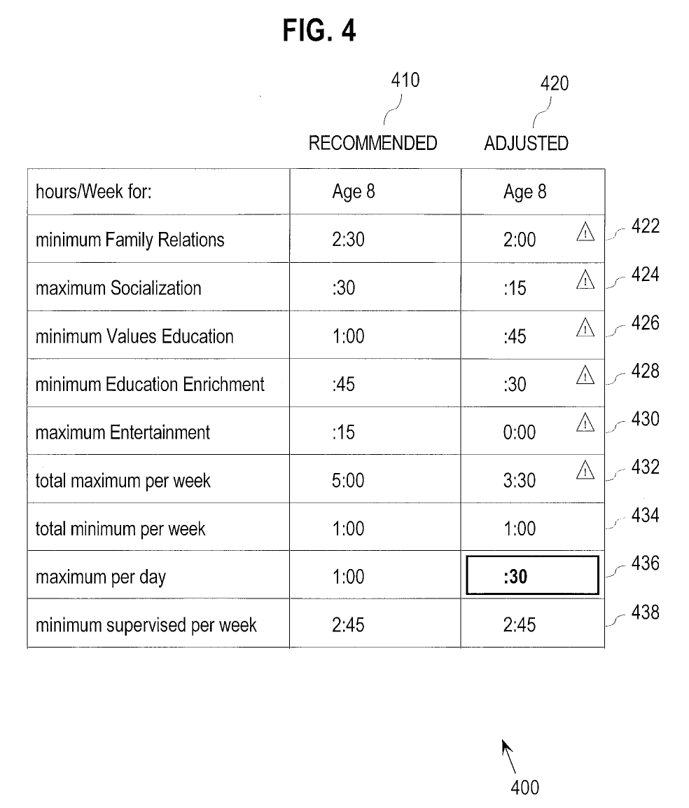

At step 206, the administrator reviews the recommended weekly media schedule, then adjusts the media schedule and approves the adjusted media schedule. In one embodiment of the invention, an administrator may approve the recommended weekly media schedule without reviewing and/or adjusting the recommended weekly media schedule. Continuing with the previous example, the administrator's web browser receives a web page that generates a graphical user interface (GUI), such as GUI 400 illustrated in FIG. 4. GUI 400 includes a recommended weekly media schedule 410 for the eight-year-old child, which is based on rules 300.

GUI 400 further includes a set of fields to receive an adjusted weekly media schedule 420 for the user, in which the administrator may change the amounts of time outlined by recommended weekly media schedule 410. In the example illustrated by GUI 400, the administrator has adjusted the maximum amount of time per day in adjusted weekly media schedule 420, at field 436, from one hour to 30 minutes. Adjustments made by administrators may affect other recommended times in the adjusted weekly media schedule 420. The adjustment made in GUI 400 at field 436 does affect other times in the media schedule.

In one embodiment of the invention, the electronic media organizer 122 automatically adjusts, in the fields for adjusted weekly media schedule 420, those times that are affected by changes made by an administrator. Automatic changes made in adjusted weekly media schedule 420 by organizer 122 may be visually indicated in GUI 400, e.g., using font type, color, labels, icons etc. Also, the pre-automatic-adjustment values may be displayed in GUI 400 to allow the administrator to quickly understand the nature of any automatic changes made by organizer 122.

To illustrate, the adjustment made by the administrator to the maximum amount of time per day in field 436 forces an adjustment to the total maximum amount of time to be spent per week for the user. This automatic adjustment may be implemented in any number of ways. In the present example, organizer 122 determines that if the maximum amount of time per day is 30 minutes, and there are seven days each week, then the maximum amount of time to be spent by the user per week is, at most, three hours and 30 minutes. Thus, as a result of the change made to field 436, organizer 122 automatically changes field 432. To highlight the automatic adjustment, a small warning icon may be displayed in the upper right corner of field 432. Fields 422-430 are also affected by the change made in field 436, and are adjusted based on the new total maximum amount of time per week in field 432. Icons are also displayed in fields 422-430 to indicate the automatic changes in these fields. The total minimum per week in field 434 and the minimum amount of supervised time in field 438 are unaffected by the adjustment made to field 436.

In another embodiment of the invention, after determining that a change made by the administrator to adjusted weekly media schedule 420 will affect other times in the adjusted media schedule, organizer 122 informs the administrator of the possible effects of the change and inquires whether the administrator would like to proceed. Such a query may be implemented as a pop up window. If the administrator indicates that she would not like to proceed, organizer 122 returns the adjusted value to the value that it had prior to the administrator's adjustment. If the administrator indicates that she would like to proceed, organizer 122 allows the change to be recorded and either a) automatically changes any affected values of adjusted weekly media schedule 420, or b) instructs the administrator as to what changes should be made to the other values of adjusted weekly media schedule 420 based on the administrator's adjustment.

Returning to flowchart 200 of FIG. 2, at step 226, organizer 122 records the adjusted weekly media schedule, e.g., adjusted weekly media schedule 420 of FIG. 4. Organizer 122 regulates a user's electronic media consumption based on the user's adjusted weekly media schedule, which helps the user to consume electronic media in manner requested by an administrator associated with the user. A user's adjusted weekly media schedule is available for review and adjustment by the associated administrators. For example, an administrator may establish log in information with organizer 122 and organizer 122 may store the adjusted weekly media schedule in conjunction with the log in information. The administrator may access the adjusted weekly media schedule, as well as the recommended weekly media schedule, by providing organizer 122 with the correct log in information.

### Daily Media Schedule

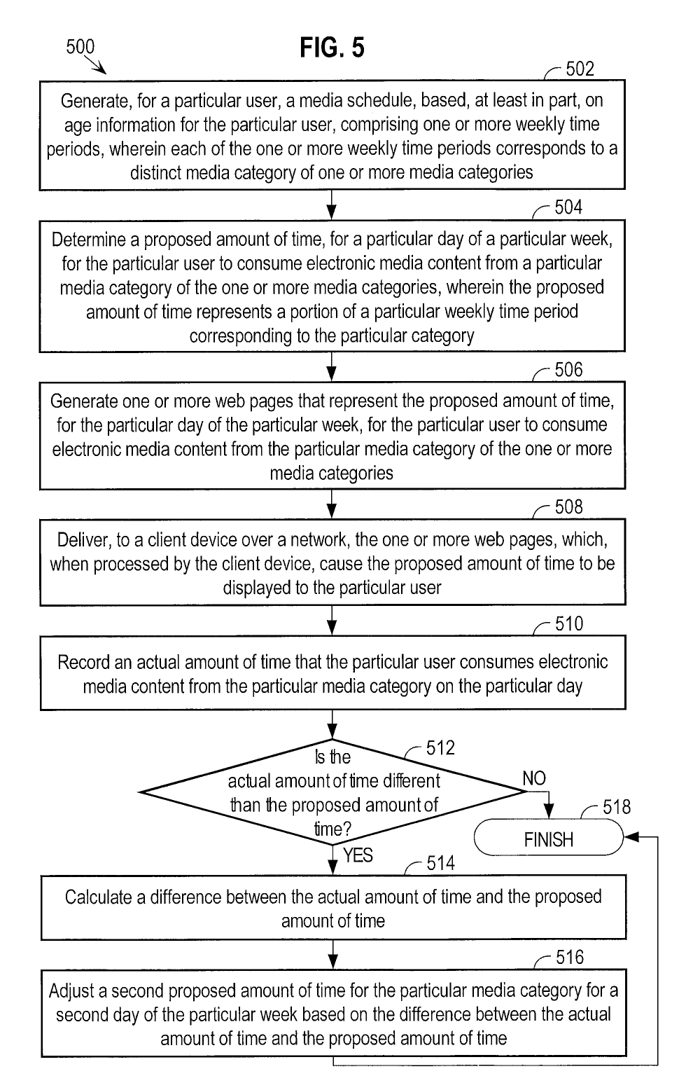

At step 228, the electronic media organizer 122 builds a daily media schedule for a user based on the adjusted weekly media schedule for the user. At step 208, the administrator creates log in information for the user that allows the user a) to access the daily and weekly media schedules created for the user, and b) to consume electronic media content based on the daily and weekly media schedules. FIG. 5 illustrates an example method 500 of generating a daily media schedule for a user based on the adjusted weekly media schedule and automatically updating the daily media schedule based on user behavior.

At step 502, a media schedule, comprising one or more weekly time periods, for a particular user is generated based, at least in part, on age information for the particular user, wherein each of the one or more weekly time periods corresponds to a distinct media category of one or more media categories. Continuing with the previous example, FIG. 4 illustrates a recommended weekly media schedule 410 for an eight-year old user, which was generated by the electronic media organizer 122 based, at least in part, on the user's age information. FIG. 4 also illustrates an adjusted weekly media schedule 420, which is based on the recommended weekly media schedule 410. An adjusted weekly media schedule may be the same as the associated recommended weekly media schedule if the administrator makes no changes. The adjusted media schedule includes weekly time periods for each Growth Opportunity media category.

At step 504, a proposed amount of time, for a particular day of a particular week, for the particular user to consume electronic media content from a particular media category of the one or more media categories is determined, wherein the proposed amount of time represents a portion of a particular weekly time period corresponding to the particular category. For example, electronic media organizer 122 determines, based on a user's adjusted weekly media schedule 410 (FIG. 4), that the user should consume electronic media for a maximum of 30 minutes every day of a particular week.

Further, electronic media organizer 122 allocates the time for each day of the particular week for consuming electronic media content from one or more Growth Opportunities. In one embodiment of the invention, organizer 122 schedules all of the days of a week at one time. In another embodiment of the invention, organizer 122 schedules one day of the week at a time, e.g., when that the user logs in that day. In this example, organizer 122 determines that, for a first day of the particular week, the user should consume electronic media content categorized under Family Relations for the full 30 minutes. Organizer 122 further determines that, for a second day of the week, the user should spend 15 minutes consuming Socialization electronic media and 15 minutes consuming Family Relations electronic media. In this case, organizer 122 will not schedule Socialization electronic media for any other day of the week because 15 minutes is the maximum amount of time that the user is allowed to spend on Socialization electronic media.

At step 506, one or more web pages are generated that represent the proposed amount of time, for the particular day of the particular week, for the particular user to consume electronic media content from the particular media category of the one or more media categories. For example, on the first day of the particular week, the user associated with adjusted weekly media schedule 420 of FIG. 4, who is using client device 110, may request, via network 130, a web page from electronic media organizer 122 that accepts log in information. The user may then log into electronic media organizer 122. As a result of the user logging in, organizer 122 generates one or more web pages that indicate the amount of time the user is to spend on media from the one or more Growth Opportunities for the first day, i.e., 30 minutes of Family Relations electronic media.

The one or more web pages generated by organizer 122 may also include a list of suggested items of electronic media that are categorized under the one or more Growth Opportunities that are scheduled for that day. In one embodiment of the invention, the user can only consume content from the list of suggested electronic media. In another embodiment of the invention, the user may consume content not on the list of suggested media items. For example, the user may be able to consume content from any media that is categorized under one or more Growth Opportunities, e.g., from Growth Opportunities that are scheduled for that day. As another example, the user may be able to consume any content that the user chooses. Organizer 122 may cut off the user's access to electronic media after the daily or weekly amount of time that is scheduled in a media schedule for the user to consume electronic media has been spent. Organizer 122 may include, in the one or more web pages, a mechanism for the user to suggest categorization of items of electronic media. Such user suggestions may be reviewed by the administrator.

At step 508, the one or more web pages are delivered to a client device over a network, which pages, when processed by the client device, cause the proposed amount of time to be displayed to the particular user. For example, electronic media organizer 122 causes server device 120 to deliver the generated web pages to client device 110 via network 130. At client device 110, browser 112 processes the web pages and causes the information in the web pages to be displayed to the user of client device 110. Thus, the user is informed that she is scheduled to consume 30 minutes of Family Relations electronic media that day.

At step 510, an actual amount of time that the particular user consumes electronic media content from the particular media category on the particular day is recorded. For example, electronic media organizer 122 records an amount of time that the user of client device 110 consumes Family Relations electronic media on the first day. To record such an actual amount of time, organizer 122 may a) record the times that the user accesses electronic media categorized under Family Relations, b) record any times that the user accesses electronic media not categorized under Family Relations, and c) record the time that the user logs off the electronic media organizer 122. The actual amount of time that the user spent consuming Family Relations electronic media content may be determined from these recorded times.

At step 512, it is determined whether the actual amount of time is different than the proposed amount of time. For example, organizer 122 scheduled the user to consume 30 minutes of Family Relations electronic media content on the first day. In this example, organizer 122 determines whether the actual amount of time spent on electronic media categorized under Family Relations is different than 30 minutes. If the actual amount of time is the same as the proposed amount of time, then method 500 finishes at step 518.

However, if the actual amount is different than the proposed amount of time at step 512, then the method continues to step 514. At step 514, a difference between the actual amount of time and the proposed amount of time is calculated. For example, organizer 122 calculates the difference between the amount of time that the user actually spent consuming Family Relations electronic media and the proposed amount of time (30 minutes). If organizer 122 determines that the user spent only 20 minutes on Family Relations electronic media on the first day, then organizer 122 calculates that the actual time is 10 minutes less than the proposed time.

At step 516, a second proposed amount of time for the particular media category for a second day of the particular week is adjusted based on the difference between the actual amount of time and the proposed amount of time. For example, organizer had originally scheduled that on the second day of the particular week, the user would spend 15 minutes consuming Socialization electronic media and 15 minutes consuming Family Relations electronic media. In response to determining that the user consumed 10 minutes less than proposed of Family Relations electronic media content on the first day, organizer 122 adjusts the schedule for the second day to include 25 minutes of Family Relations electronic media and five minutes of Socialization media. As a further example, organizer 122 adjusts the daily media schedule for the second day to include 30 minutes of Family Relations time and zero minutes of Socialization time. Adjustments to the daily media schedule for a user may be based on any number of algorithms. For example, such adjustments may be based a) on the relative importance of Growth Opportunities (either pre-set in organizer 122, or as determined by administrators); b) on the track record of the user; or c) on any number of other factors.

A user may be informed of the user's updated daily media schedule. Organizer 122 may cause one or more updated web pages to be generated, e.g., at server device 120, which reflect the updated daily media schedule. The updated web pages may be delivered to a client device for the user, such as client device 110 (FIG. 1), over network 130. Browser 112 at client device 110 may process the updated web pages and display to the user the updated daily media schedule. The web pages may be delivered to the user when the user has finished the user's electronic media content consumption time for the first day, or when the user logs in to organizer 122 on the second day, etc.

In one embodiment of the invention, when a user reaches or exceeds the amount of time allocated to a particular Growth Opportunity in the user's adjusted weekly media schedule in a particular week, organizer 122 prevents the user from consuming electronic media categorized under the particular Growth Opportunity for the rest of the week. In this embodiment of the invention, if electronic media may be categorized under both the exhausted Growth Opportunity and an alternative Growth Opportunity, then organizer 122 may a) automatically prevent the user from accessing the electronic media, b) allow the user to access the electronic media that week under the alternative Growth Opportunity, or c) allow the administrator associated with the user to determine whether or not to allow the electronic media to be consumed that week. In another embodiment of the invention, organizer 122 only prevents a user from consuming electronic media from a particular Growth Opportunity if the amount of time allocated for the Growth Opportunity is designated as a maximum amount of time. In yet another embodiment of the invention, the user is not prevented from consuming electronic media under an exhausted category. Organizer 122 may provide the user with a notice that electronic media requested by the user is categorized under an exhausted Growth Opportunity.

### Determining a Schedule of Supervised Media Consumption

The adjusted weekly media schedule for a user includes a minimum amount of time for supervised electronic media content consumption, as illustrated in field 438 of FIG. 4. Electronic media organizer 122 may suggest to an administrator one or more individuals to supervise a user's electronic media consumption. For example, a parent, an older sibling, a grandparent, a guardian, or other adult may be recommended by organizer 122 to supervise the media consumption of the user during the suggested supervised time. A person authorized to supervise a user's media consumption is referred to herein as a supervisor.

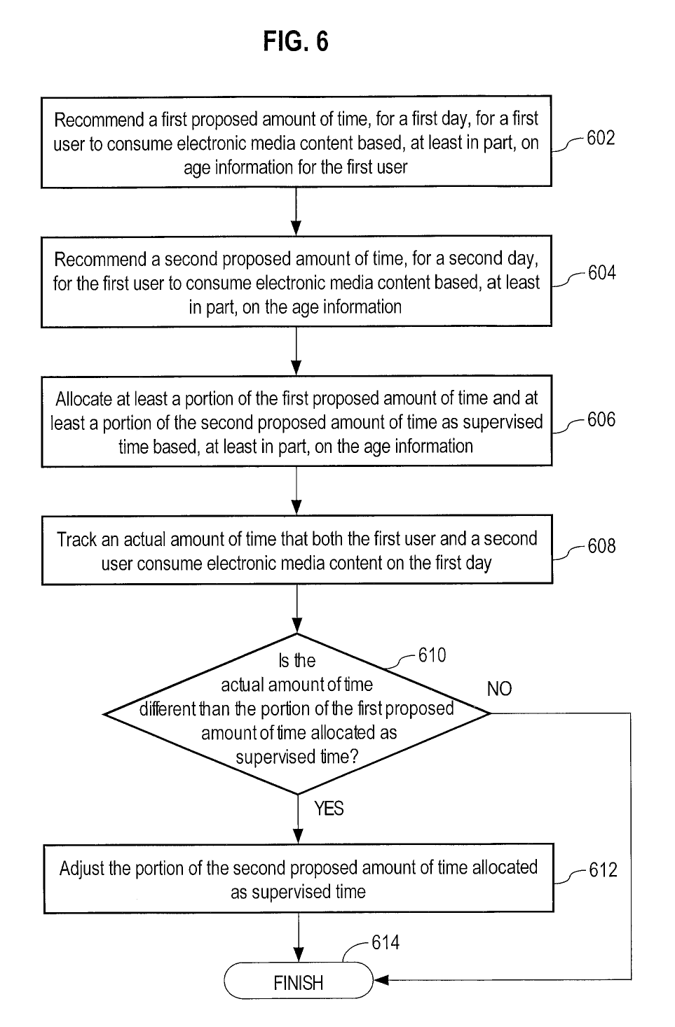

FIG. 6 illustrates an example method 600 of generating a daily schedule of supervision for a user, monitoring the actual supervised electronic media content consumption time, and adjusting the daily schedule of supervision based on the actual supervised time. At step 602, a first proposed amount of time, for a first day, for a first user to consume electronic media content is recommended based, at least in part, on age information for the first user. At step 604, a second proposed amount of time, for a second day, for the first user to consume electronic media content is recommended based at least in part, on the age information. For example, electronic media organizer 122 recommends that a user spend 30 minutes consuming electronic media content on a first day of a particular week, and 30 minutes consuming electronic media content on a second day of the particular week, based on the adjusted weekly media schedule for the user, e.g., adjusted weekly media schedule 420 (FIG. 4).

At step 606, at least a portion of the first proposed amount of time and at least a portion of the second proposed amount of time are allocated as supervised time based, at least in part, on the age information. Continuing with the previous example using adjusted weekly media schedule 420 of FIG. 4, organizer 122 allocates a portion of the 30 minutes of media consumption time on the first day and a portion of the 30 minutes of media consumption time on the second day as supervised time based on the requirement that the child be supervised for at least two hours and 45 minutes during the particular week (field 438). Organizer 122 may use any algorithm to allocate the portions of supervised time. In this example, organizer 122 determines that 15 minutes of time on each of the first and second days should be supervised time. An amount of time allocated as supervised time for a particular day may be the entire amount of electronic media content consumption time allocated for the day.

In one embodiment of the invention, organizer 122 uses the received information about the supervisor schedules to schedule times during the first and second days as supervised media consumption time. For example, an administrator may inform organizer 122 that a supervisor is available to supervise a user's media consumption from 6:00 PM to 7:00 PM each day of any given week. Thus, referring to the previous example, organizer 122 schedules supervised time for the user from 6:00 PM to 6:15 PM on both the first day and the second day.

The daily schedule of supervision is adjustable by the administrator. For example, a supervisor may have an appointment during the scheduled supervised time on the first day. Thus, administrator may adjust the daily schedule of supervision to include no supervised time on the first day. Based on this adjustment, organizer 122 may determine whether the administrator would like to move the supervised time to another day of the week, e.g., the second day, or skip the eliminated 15 minutes of supervised time that particular week. Furthermore, organizer 122 may give the administrator the option to permanently implement the changes.

At step 608, an actual amount of time that both the first user and a second user consume electronic media content on the first day is tracked. For example, organizer 122 may track the amount of time that a user is supervised by requesting that a supervisor log into organizer 122 when the supervisor begins supervising the media consumption of the user, and that the supervisor log out when finished. Thus, the organizer may track the amount of time that the user is supervised by tracking how much time both the user and the supervisor are both logged into the system at the same time. In one embodiment of the invention, organizer 122 prevents a user from consuming electronic media without supervision during time allocated as supervised.

To log into or out of the organizer 122, a user or administrator may use typed log in information, an eye scanner, voice detection, face recognition, fingerprint identification, and any other method of identifying a person to organizer 122.

Other methods of determining whether a user was supervised during the scheduled supervised media consumption time may be implemented by organizer 122, including determining that a user was supervised based on a statement by the supervisor, periodic explicit or implicit requests for information from the supervisor, continuous detection of the presence of the supervisor, e.g., through voice recognition, facial recognition, fingerprint identification, etc. Furthermore, part or all of the allocated supervised time may be considered sufficiently supervised if a supervisor is present in the same living space as the user while the user consumes electronic media content.

Returning to FIG. 6, at step 610, it is determined whether the actual amount of time is different than the portion of the first proposed amount of time that is allocated as supervised time. If not, method 600 finishes at step 614.

However, if the test at step 610 is positive, then control moves to step 612. At step 612, the portion of the second proposed amount of time allocated as supervised time is adjusted. Continuing with the previous example, at the end of the first day, organizer 122 determines that none of the time that the user consumed electronic media content that day was supervised. In this example, the user was not locked out of the system without supervision. Because organizer 122 had allocated 15 minutes of supervised time for the first day, which is different than the 0 minutes of electronic media consumption that was actually supervised the first day, organizer 122 adjusts the allocated amount of supervised time for the second day. In this example, organizer 122 allocates the entire 30 minutes of electronic media consumption time scheduled for the second day as supervised time. Alternatively, organizer 122 may adjust the supervised time that is allocated for several days based on over- or under-supervision on a particular day.

### Selecting Electronic Media for Consumption

Returning to FIG. 2, at step 242, a user submits a unique biometric or passcode to organizer 122 to unlock the user's weekly/daily media schedule. For example, a user on client device 110 (FIG. 1) may use any of the following to identify herself to organizer 122: typed log in information, voice, fingerprints, retinal scan, hair analysis, saliva, etc. Once organizer 122 identifies the user, organizer 122 causes the user to view a media schedule associated with the user. Information used to identify a user to organizer 122 may include or exclude a password. In one embodiment of the invention, organizer 122 displays the user's adjusted weekly media schedule. In another embodiment of the invention, organizer 122 displays daily media schedule information for the particular day.

The media schedule information displayed to the user may include a total amount of time allocated for electronic media consumption for a particular day, the amount of time for the day that is allocated as supervised time, and/or the Growth Opportunities and amounts of time for the Growth Opportunities scheduled for the day. For example, organizer 122 may indicate to the user, via a web page that is transmitted to client device 110 via network 130 and interpreted by browser 112, that the user is scheduled for 30 minutes of electronic media consumption for the day. Organizer 122 may also indicate to the user that the user is scheduled for supervised time from 6:00 PM to 6:15 PM that day. Further, organizer 122 may indicate to the user that all 30 minutes of electronic media consumption time is allocated for Family Relations electronic media.

Organizer 122 may also display a list of electronic media that are categorized under the Growth Opportunities scheduled for the day. The organizer may compile such a list in any number of ways. For example, organizer 122 may include in the list all items categorized under a particular Growth Opportunity for the user. Organizer 122 may track a user's progress in a particular item of electronic media, and based on incomplete progress, include the particular item in the list. Also, organizer 122 may include electronic media, in the list, that are highly ranked by a) the administrators associated with the user, b) the user, c) other administrators associated with organizer 122, or d) by other sources of ranking information. Additionally, an administrator may compile part or all of the list of electronic media for a particular day. Organizer 122 may include, in the list, electronic media that the user has not yet consumed. All items on the list may be equally visually weighted, or some items on the list may be visually emphasized using font style, font color, icons, list item placement, labels, etc.

Upon a user logging in, organizer 122 may simply route the user to a particular item of electronic media for the day instead of presenting a list of electronic media to the user. Organizer 122 may directly route a user to a particular item of media, e.g., when an administrator associated with the user has indicated that the user is required to participate in the particular electronic media item.

### Monitoring and Providing Feedback on User Behavior

Returning to flowchart 200 of FIG. 2, at step 230, electronic media organizer 122 monitors the media usage of a user and provides feedback on the media usage. In one embodiment of the invention, electronic media organizer 122 monitors a user's behavior during consumption of electronic media content and records particulars of the behavior, e.g., in database 140 (FIG. 1). As indicated previously, organizer 122 monitors the amount of time a user spends consuming electronic media content each day and each week. Organizer 122 also monitors how much time the user has spent in a week on electronic media categorized under each Growth Opportunity. Such monitoring may be automatic as described above, or time information may be requested from the user after the time has been spent consuming electronic media.

Organizer 122 may monitor many aspects of a user's electronic media consumption. For example, organizer 122 may record unique identifiers of electronic media consumed by a user and the durations of time spent on each media item. Also, organizer 122 may monitor a user's behavior while the user is consuming electronic media. For example, organizer 122 may use voice detection technology to monitor the user's language. Organizer 122 may also monitor the user's typed words. Organizer 122 may thus determine if a user is saying or typing inappropriate things, such as swear words, while the user consumes particular items of electronic media. According to administrator preference, instances of inappropriate behavior may simply be recorded, may cause organizer 122 to give a warning message to the user, and/or may cause organizer 122 to terminate a user's access to the particular media.

Organizer 122 may also use motion detectors, including optical motion detectors, step/dance pads, and other motion detectors, to monitor a user's physical activity during electronic media consumption. The organizer may also monitor a user's pulse rate or skin conductance, as used in psychological experiments to measure a person's anxiety levels.

Feedback may be provided to the user based on the observed behavior of the user. An administrator may set various levels of strictness of rule enforcement by organizer 122 to accommodate user characteristics such as trustworthiness and maturity. Accordingly, organizer 122 may strictly or loosely enforce time limits. Organizer 122 may determine that a user is not conforming to a particular time limit from the user's media schedule, associated with a particular Growth Opportunity, upon determining that the user has spent an amount of time with media from the particular Growth Opportunity that falls outside a given range of the proposed amount of time for the Growth Opportunity.

For example, an administrator may indicate that a user is not conforming to a time amount for Socialization media consumption if the user has consumed ten minutes or more beyond the time limit set in the weekly media schedule for the user. The administrator may set any kind of time range for non-conformance to a particular goal set in the media schedule. In the given example, when the user has consumed Socialization media for ten minutes more than the user's allotted weekly time limit for socialization, organizer 122 may cut off the user's access to a particular item of electronic media, to a category of electronic media, or to electronic media all together. Also, organizer 122 may provide a user with warnings when the user does not conform to the weekly or daily media schedule for the user. Organizer 122 may also simply provide feedback to an administrator for a user that is not conforming to a media schedule for the user, without providing any feedback to the user.

A user may be rewarded for conforming to one or more aspects of the media schedule set for the user. Organizer 122 may determine that a user has conformed to a particular time amount associated with a particular Growth Opportunity upon determining that the user has spent an amount of time with media from the particular Growth Opportunity that falls within a given range of the proposed amount of time for the Growth Opportunity. For example, the electronic media schedule for a user indicates that the user should spend one hour consuming Values Education media. The administrator further indicates to organizer 122 that the Values Education time amount of the media schedule is fulfilled if the user spends one hour or more on Values Education for the week. The administrator may set any kind of time range for fulfillment of a particular goal set in the media schedule. In this example, organizer 122 determines that the user has conformed to the Values Education time amount in the media schedule when the user has spent one hour or more on Values Education media.

Conformance to a time amount indicated in the media schedule may earn the user a reward. A visual reward like a star or smiley face may be placed on the user's log in screen, which may be effective for young children. Also, a user may be rewarded with more time for Socialization electronic media or Entertainment electronic media as a result of diligently completing time goals for one or more of the Growth Opportunities. Furthermore, an administrator may manually give a reward to a user, e.g., for accomplishments at home, at school, or in the community, or on special occasions, etc.

Also, a user may be informed of the user's progress with respect to the time goals for Growth Opportunities for a given week. For example, organizer 122 generates and causes server device 120 to send a web page to client device 110, which is being used by a particular user, to visually describe the particular user's progress on the user's weekly media schedule. Such a web page may include graphs and/or summaries of time spent on electronic media from particular Growth Opportunities and further time required to conform to the weekly or daily media schedule for the user. Such a summary may also include analysis or summary of past performance of the user.

Organizer 122 may also provide, to an administrator, feedback on an associated user's electronic media consumption. As with feedback to the user, organizer 122 may generate a web page that visually represents aspects of the user's progress on the user's media schedule and/or the user's behavior. Such feedback may also include details of the user's behavior or trends in the user's behavior over time. Organizer 122 may indicate in feedback to an administrator how the adjusted media schedule deviates from the media schedule originally suggested by the organizer.

With the feedback, organizer 122 may request information from the administrator. For example, if a user has not been supervised as much as was prescribed in the user's media schedule, organizer 122 may ask the administrator if the user was supervised in a manner that was not detected by organizer 122. Also, organizer 122 may flag an electronic media item consumed by the user that may be included under multiple Growth Opportunities and ask that the administrator choose a particular Growth Opportunity in which to categorize the time spent on that electronic media. Organizer 122 may provide the administrator with suggestions on categorizing ambiguous media consumption time, e.g., based on deficits in the user's performance for particular Growth Opportunities, based on stated needs of the user, based on how other administrators categorize the time, or based on past choices made by the administrator, etc. Also, the administrator may determine that time spent on a particular electronic media that may be categorized under multiple Growth Opportunities be counted under two or more of the Growth Opportunities

Feedback to administrators may also include information about the behavior and media schedules of other users. For example, if an administrator is associated with a group of administrators, organizer 122 may provide the administrator with feedback comparing the users associated with the administrator with users associated with the group as a whole. Also, an administrator may be provided with information on how users with attributes similar to the attributes of the users associated with the administrator perform, and what the users' media schedules look like. As such, an administrator may have access to norms of users similar to the administrator's users.

Furthermore, organizer 122 may analyze the feedback information for a user given to an administrator in any number of ways. For example, organizer 122 may track, analyze, and report to the administrator reaction times, distractibility, impulsivity, aggressiveness, passivity, assertiveness, generosity, patience, social skills, memory, intelligence, morality, creativity, academic achievement level, sensorimotor skills, rates of keyboarding and multitasking, language usage patterns such as quantities and qualities of verbal content, and unusual deviation from prior performance by the user or from group norms in any measure tracked. Organizer may gather data on such user behavior through any number of methods, including voice recognition, data directly input to a device through input devices such as a mouse or keyboard, monitoring of vital signs, etc.

Organizer 122 may deliver feedback to administrators and users in any number of ways, e.g., via email, via a newsgroup, as a visual representation on a log in screen, or via a web page that is accessible by a) the administrator only, b) by a group of administrators, or c) by any administrator associated with organizer 122. In one embodiment of the invention, feedback that is accessible by multiple administrators does not specifically identify information about a particular user associated with the group. Such group feedback may show information on how much media consumption time users are spending daily, weekly, with electronic media categorized under particular Growth Opportunities, or with a particular item of electronic media singly. Group feedback may also indicate how closely the media schedules for users conform to the media schedules suggested by organizer 122 and how closely users follow their media schedules. Such group feedback may also include details on the behavior of users in the group.

At step 210, an administrator may monitor and refine weekly or daily media schedules for a user. For example, based on the feedback provided by organizer 122, an administrator may adjust one or more time amounts in the adjusted weekly media schedule for a user. Organizer 122 may provide suggestions for adjusting the weekly media schedule. Also, discussion with the user may reveal ways that the administrator should adjust the user's weekly or daily media schedule.

### Video Game Based on the Media Schedule

Server device 120 may also be configured with a balanced video game 124 that uses information from media schedules developed by administrators through electronic media organizer 122. Users may access video game 124 through client device 110, via network 130. Alternatively, video game 124 may reside on client device 110 and communicate with electronic media organizer 122 via network 130.

Video game 124 described herein may depict a life-space that allows video game 124 to present modules, such as challenges, puzzles, games, etc., that may be categorized under one or more of the Growth Opportunities. These modules may be presented to a user in such a way as to maintain the balance set forth in the user's weekly media schedule. Thus, an administrator/parent may control the substance of video game 124 by way of the weekly media schedule that the parent has developed for a user/child. Video game 124 may also use other information about the user stored by organizer 122, e.g., at database 140, such as age information, special needs of the user, etc. Video game 124 may base the modules presented to the user on the information retrieved from organizer 122, therefore allowing the psychological, motor, and sensory experiences attained by the user through video game 124 to be appropriate for the age and attributes of the user. For example, a challenge that requires fine motor skills may be adjusted by video game 124 based on the user's age.

Video game 124 is customizable by administrators and users. For example, a child may express to his parent a desire to be a fire fighter when he grows up. As an administrator, the parent may access the settings of video game 124 and choose modules for the child that allow him to explore the world of a fire-fighter in an age-appropriate manner. Video game 124 may allow the administrator or user to choose an avatar for the user that is dressed as a fire fighter, and which may also have other attributes that please the user. Video game 124 may also automatically choose modules to present to the user that are similar or complementary to the modules selected by the administrator.

Furthermore, video game 124 may allow the user to interact with other users during game play. Such interaction may be controlled by the administrator. For example, an administrator may allow a user to interact only with people from a certain group or groups associated with organizer 122, or with people that have particular attributes. Also, an administrator may block or allow interaction with specific other users.

Furthermore, an administrator may monitor and/or limit, through video game 124 or organizer 122, the quality of interactivity by a user, such as collaborative, assertive, aggressive, or competitive interaction, etc. For example, voice recognition may allow video game 124 to track a number of times a user says words that are included in a list of aggressive indicators. Based on the frequency that a user uses aggressive indicators, video game 124 may classify a certain time period of video game play by the user as aggressive interaction. An administrator may set a time limit for the user to have aggressive interaction with another player, e.g., 30 minutes per day. Once a certain amount of time equaling the time limit has been labeled as aggressive interaction, video game 124 may terminate the user's ability to interact with the person that has been the recipient of her aggressive interaction. Video game 124 may also simply track the quality of interactivity of the user for feedback to an associated administrator, or may give warnings to the user based on the quality of interactivity of game play. Any number of methods could be used to track quality of a user's interactivity, including tracking words typed, and tracking vital signs of the user, etc. Video game 124 and/or organizer 122 may use other methods of content analysis to monitor and track the quality of a user's interactivity.

Video game 124 may also track, analyze, and report, the same kinds of feedback information for administrators as organizer 122. For example, video game 124 may use the capabilities of organizer 122 to monitor behavior of a user and provide feedback to users and administrators. Also, organizer 122 may monitor and provide feedback on the quality of interactivity by a user, as described in connection with video game 124.

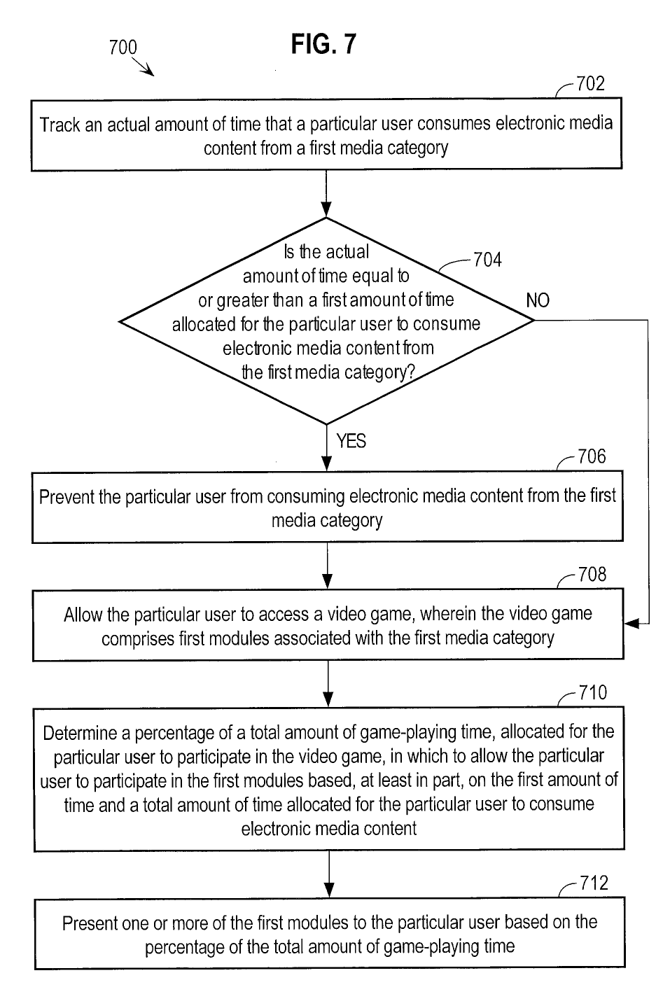

FIG. 7 illustrates an example method 700 of basing the presentation of video game modules to a user on a weekly media schedule for the user. At step 702, an actual amount of time that a particular user consumes electronic media content from a first media category is tracked. For example, organizer 122 tracks a number of minutes, 90 minutes, that a particular user consumes content from a web page that is categorized under Socialization.

At step 704, it is determined whether the actual amount of time is equal to or greater than a first amount of time allocated for the particular user to consume electronic media content from the first media category. For example, organizer 122 determines that the media schedule for the particular user allows only one hour of each of the Growth Opportunities per week. As such, organizer 122 determines that the actual amount of time that the particular user has spent on Socialization electronic media (90 minutes) exceeds the weekly allotted time for that Growth Opportunity (60 minutes).

If the test at step 704 is positive, then control passes to step 706. At step 706, the particular user is prevented from consuming electronic media content from the first media category. For example, organizer 122 restricts the particular user's access to all electronic media categorized under Socialization for the rest of the week, which constitutes strict enforcement of the user's weekly media schedule.

Control passes to step 708 either after step 706, or if the test of step 704 is negative. At step 708, the particular user is allowed to access a video game, wherein the video game comprises first modules associated with the first media category. For example, the particular user accesses video game 124, which includes one or more modules that are categorized under Socialization. The Socialization modules may be categorized as such a) automatically by video game 124, b) automatically by organizer 122, or c) by an administrator associated with the particular user.

At step 710, a percentage of a total amount of game-playing time, allocated for the particular user to participate in the video game, in which to allow the particular user to participate in the first modules is determined based, at least in part, on the first amount of time and a total amount of time allocated for the particular user to consume electronic media content. For example, an administrator may allocate a certain amount of time, e.g., two and a half hours per week, for the particular user to play video game 124. Video game 124 may determine a Socialization percentage of that video-game playing time based on the information in the media schedule for the particular user. In this example, the particular user is allowed to spend five hours consuming electronic media content, not including the time allocated for playing video game 124. One hour is allocated in the user's adjusted weekly media schedule for electronic media from each of the following Growth Opportunities: Family Relationships, Values Education, Socialization, Education Enrichment, and Entertainment. Thus, video game 124 determines that ⅕ of the game playing time allocated for the particular user, or 20%, is to be dedicated to Socialization modules.

At step 712, one or more of the first modules are presented to the particular user based on the percentage of the total amount of game-playing time. For example, video game 124 may strictly limit the amount of time that a user spends in Socialization modules to 20% of the total allotted time for playing the video game. Alternatively, video game 124 may allow a user to spend more time in Socialization modules in one week and present to the user less Socialization modules the next week to maintain the balance set by the media schedule over time. Administrators may set the strictness of adherence of video game 124 to the proportions of Growth Opportunities in the media schedule for the user.

As a further illustration using the previous example, video game 124 determines that 20% of the total video game playing time should be dedicated to Values Education modules, based on the adjusted weekly media schedule for the particular user. Thus, video game 124 presents Values Education modules to the user for 20% of the time allocated for game playing for the user, as described above.

Video games can be very compelling, and a young mind may have trouble distinguishing a very compelling video game from reality. Video game 124 may facilitate a user's transition from virtual reality to reality. For example, when a user has come to the end of game play, e.g., by the user's request, or because the user has no more allotted game playing time, etc., video game 124 may perform one or more actions to help the user transition to reality. Video game 124 may slowly dissolve the electronic scene presented by the game at the end of game play, may ask a child to personally interact with a human, and/or may ask orienting questions, such as the current time, the user's location, details of the day, etc. Video game 124 may also alert a supervisor for the child, such as a parent, grandparent, older sibling, as to the user's transition between virtual reality and reality. Video game 124 may request that the supervisor interact with the child or the game to facilitate the transition.

Also, video game 124 may gather data on the user's reactions to the video game, including the user's game play, ability to transition from virtual reality to reality, vital signs, behavior, etc. For example, video game 124 may measure the user's attention span or reaction time during game play. Also, the game may use one or more detection devices to monitor the user's vital signs, such as heart rate, skin conductance, etc, and to monitor language and other behavior. Video game 124 may provide feedback to the user and/or administrator on the user's behavior while playing the video game, in a manner similar to that described above with respect to feedback from organizer 122. User reactions that are tracked by video game 124 may include any and all of the information tracked by organizer 122, and may be tracked using the same software or devices as used by organizer 122.

Video game 124 may reward points in a randomized fashion, such that the user does not know an amount of points received for any given choice in the video game based on past game play. Thus, video game 124 may present to a user a module that has at least two outcomes, and in which the user must choose between the outcomes either directly or indirectly based on the user's game play. If the user chooses an outcome that is considered positive, the video game may reward the user points. In one embodiment of the invention, the points rewarded to the user are completely random and may be positive or negative. In another embodiment of the invention, the points awarded to the user based on the choice are random within a range of values. Such limited randomness ensures larger, but varying, point values for bigger accomplishments, and smaller varying point values for smaller accomplishments.

### Implementation Mechanisms

According to one embodiment, the techniques described herein are implemented by one or more special-purpose computing devices. The special-purpose computing devices may be hard-wired to perform the techniques, or may include electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

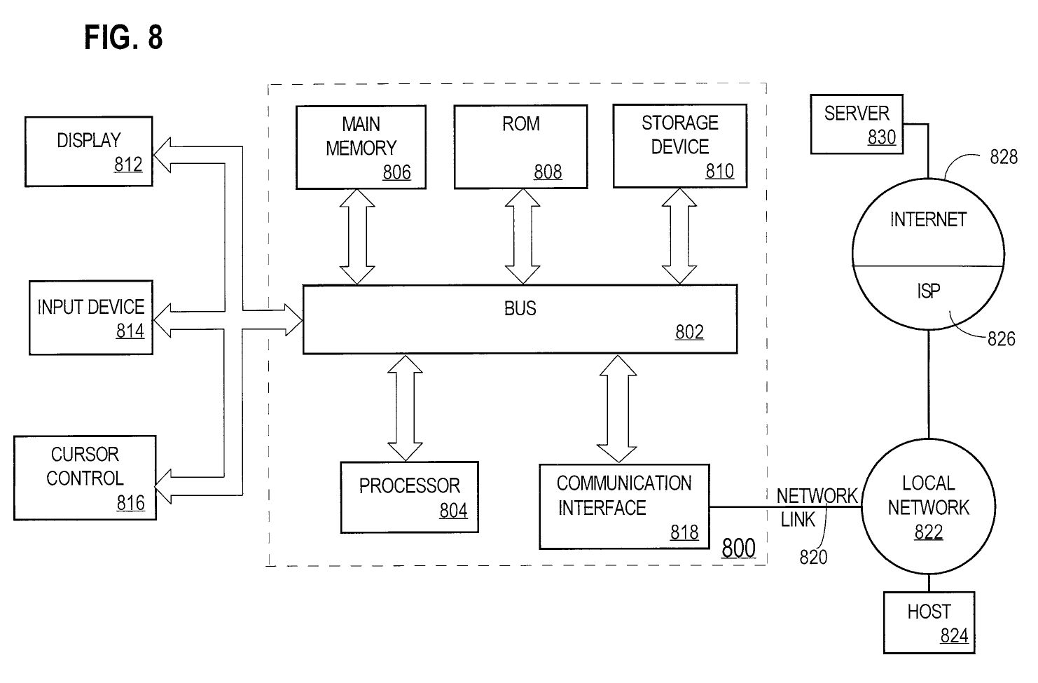

For example, FIG. 8 is a block diagram that illustrates a computer system 800 upon which an embodiment of the invention may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services electronic network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry electronic data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry electronic data streams. The signals through the various networks and the signals on network link 820 and through communication interface 818, which carry the electronic data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
generating, for a particular user, a media schedule, based, at least in part, on age information for the particular user, comprising one or more weekly time periods;
wherein each of the one or more weekly time periods corresponds to a distinct media category of one or more media categories;
determining a proposed amount of time, for a particular day of a particular week, for the particular user to consume electronic media content from a particular media category of the one or more media categories;
wherein the proposed amount of time represents a portion of a particular weekly time period corresponding to the particular media category;
generating one or more web pages that represent the proposed amount of time, for the particular day of the particular week, for the particular user to consume electronic media content from the particular media category of the one or more media categories;
delivering, to a client device over a network, the one or more web pages, which, when processed by the client device, cause the proposed amount of time to be displayed to the particular user;
recording an actual amount of time that the particular user consumes electronic media content from the particular media category on the particular day;
determining whether the actual amount of time is different than the proposed amount of time;
in response to determining that the actual amount of time is different than the proposed amount of time:
calculating a difference between the actual amount of time and the proposed amount of time; and
adjusting a second proposed amount of time for the particular media category for a second day of the particular week based on the difference between the actual amount of time and the proposed amount of time.

2. The method of claim 1, further comprising:
generating one or more updated web pages that represent the adjusted second proposed amount of time, for the second day of the particular week;
delivering, to the client device over the network, the one or more updated web pages, which, when processed by the client device, cause the adjusted second proposed amount of time to be displayed to the particular user.

3. The method of claim 1, further comprising reporting the actual amount of time that the particular user consumes electronic media content from the particular media category on the particular day to an administrator that is associated with the particular user.

4. The method of claim 1, further comprising:
automatically assigning a set of one or more media to the particular media category;
wherein media of the set of one or more media includes one or more of a group of media that includes: a) a web page, b) a video game, c) a movie, d) a television program, e) a telephone call, f) applications run on a computing device, and g) other electronic entertainment.

5. The method of claim 4, further comprising suggesting, to the particular user on the particular day, one or more media from the set of one or more media assigned to the particular media category.

6. The method of claim 4, wherein the set of one or more media includes two or more of the group of media, further comprising:
displaying the media from the set of media on a single device;
wherein the method is performed by a controller on the single device.

7. The method of claim 4, wherein the step of automatically assigning a set of one or more media to the particular media category is based, at least in part, on information included in data for the set of one or more media by a provider of the set of one or more media.

8. The method of claim 1 further comprising:
sending media preference information for the particular user to a media provider;
receiving, from the media provider, particular electronic media content that conforms to the media preference information; and
allowing the particular user to consume the particular electronic media content.

9. The method of claim 1, further comprising:
in response to determining that the actual amount of time is within a given range of the proposed amount of time, increasing a second proposed amount of time for consuming electronic media categorized under one or more of the media categories.

10. One or more computer-readable storage media storing instructions which, when executed by one or more computing devices, cause performance of the method recited in claim 1.

11. An apparatus comprising:
one or more processors;
a computer-readable storage medium storing instructions which, when executed by the one or more processors, cause a computing device to perform:
generating, for a particular user, a media schedule, based, at least in part, on age information for the particular user, comprising one or more weekly time periods;
wherein each of the one or more weekly time periods corresponds to a distinct media category of one or more media categories;
determining a proposed amount of time, for a particular day of a particular week, for the particular user to consume electronic media content from a particular media category of the one or more media categories;
wherein the proposed amount of time represents a portion of a particular weekly time period corresponding to the particular media category;
generating one or more web pages that represent the proposed amount of time, for the particular day of the particular week, for the particular user to consume electronic media content from the particular media category of the one or more media categories;
delivering, to a client device over a network, the one or more web pages, which, when processed by the client device, cause the proposed amount of time to be displayed to the particular user;
recording an actual amount of time that the particular user consumes electronic media content from the particular media category on the particular day;
determining whether the actual amount of time is different than the proposed amount of time;
in response to determining that the actual amount of time is different than the proposed amount of time:
calculating a difference between the actual amount of time and the proposed amount of time; and
adjusting a second proposed amount of time for the particular media category for a second day of the particular week based on the difference between the actual amount of time and the proposed amount of time.

12. A computer-implemented method comprising:
based, at least in part, on age information for a first user, recommending a first proposed amount of time, for a first day, for the first user to consume electronic media content;
based, at least in part, on the age information, recommending a second proposed amount of time, for a second day, for the first user to consume electronic media content;
based, at least in part, on the age information, allocating at least a portion of the first proposed amount of time and at least a portion of the second proposed amount of time as supervised time;
tracking an actual amount of time that both the first user and a second user consume electronic media content on the first day;
determining whether the actual amount of time is different than the portion of the first proposed amount of time allocated as supervised time;
in response to determining that the actual amount of time is different than the portion of the first proposed amount of time allocated as supervised time, adjusting the portion of the second proposed amount of time allocated as supervised time.

13. The computer-implemented method of claim 12, wherein the second user consumes electronic media content by being present in the same living space as the first user.

14. The computer-implemented method of claim 12, wherein tracking the actual amount of time that both the first user and the second user consume electronic media content on the first day further comprises tracking an amount of time, on the first day, that the first user and the second user are both logged onto a system for tracking time.

15. A computer-implemented method comprising:
tracking an actual amount of time that a particular user consumes electronic media content from a first media category;
determining whether the actual amount of time is equal to or greater than a first amount of time allocated for the particular user to consume electronic media content from the first media category;
in response to determining that the actual amount of time is equal to or greater than the first amount of time, preventing the particular user from consuming electronic media content from the first media category;
allowing the particular user to access a video game;
wherein the video game comprises first modules associated with the first media category;
determining a percentage of a total amount of game-playing time, allocated for the particular user to participate in the video game, in which to allow the particular user to participate in the first modules based, at least in part, on the first amount of time and a total amount of time allocated for the particular user to consume electronic media content;
presenting one or more modules of the first modules to the particular user based on the percentage of the total amount of game-playing time.

16. The computer-implemented method of claim 15, wherein the video game further comprises second modules associated with a second media category, further comprising:
determining a second percentage of the total amount of game-playing time, allocated for the particular user to participate in the video game, in which to allow the particular user to participate in the second modules based, at least in part, on a second amount of time allocated for the particular user to participate in media from the second media category and the total amount of time allocated for the particular user to participate in media;
presenting one or more modules of the second modules to the particular user based on the second percentage of the total amount of game-playing time.

17. The computer-implemented method of claim 15, further comprising:
prior to terminating the particular user's access to the video game, performing one or more of:
presenting orienting questions to the particular user;
slowly fading the media from the view of the particular user; and
facilitating the particular user's immediate interaction with humans.

18. The computer-implemented method of claim 15, further comprising:
monitoring one or more reactions of the particular user while the particular user participates in the video game;
determining whether a particular reaction of the one or more reactions has a specified characteristic; and
in response to determining that the particular reaction of the one or more reactions has the specified characteristic, notifying a second user of the particular reaction.

19. The computer-implemented method of claim 18:
wherein the one or more reactions of the particular user comprises words expressed by the particular user while the particular user participates in the video game; and
wherein the step of determining whether a particular reaction of the one or more reactions has a specified characteristic further comprises determining whether a particular word or phrase expressed by the particular user is included in a list of words and phrases.

20. The computer-implemented method of claim 15, wherein the one or more modules of the first modules includes a decision with at least two outcomes, and wherein a first outcome of the at least two outcomes is positive, further comprising:
presenting the decision to the particular user, wherein the particular user is required to choose an outcome of the at least two outcomes;
determining whether the particular user chose the first outcome;
in response to determining that the particular user chose the first outcome, automatically awarding the particular user a quantity of points;
wherein the quantity of points is randomly determined based, at least in part, on a magnitude of points associated with the first outcome and at least one random factor.
